(19) United States
(12) Patent Application Publication
(10) Pub. No.: US 2017/0343286 A1
(43) Pub. Date: Nov. 30, 2017

(54) AUTOMATED TAPPING SYSTEM FOR GASIFICATION REACTORS

(71) Applicant: Alter NRG Corp., Calgary (CA)

(72) Inventors: Lucas Alexander Brown, Oakville (CA); Kerry Johannes McKenna, Toronto (CA)

(21) Appl. No.: 15/165,646

(22) Filed: May 26, 2016

(51) Int. Cl. F27D 3/14; F27D 11/06

(52) U.S. Cl. CPC F27D 3/14; F27D 11/06

(57) ABSTRACT

A tapping system for removing molten fluid from a vessel, the tapping system includes: a taphole assembly configured to receive molten fluid from a vessel; an induction coil encircling at least a portion of a taphole channel in the taphole assembly; a launder assembly configured to receive fluid exiting the taphole channel and to form a pressure seal; and a plasma torch extending into the vessel and configured to direct a plasma plume toward an inlet of the taphole channel.

### FIELD OF THE INVENTION

This invention relates to gasification reactors, and more particularly to tapping systems for such reactors.

### BACKGROUND

In process vessels such as municipal solid waste (MSW) gasifiers and electric arc furnaces (EAFs), molten fluid (e.g. slag, metal) is removed through an opening in the vessel wall termed a “taphole”. Molten fluid exiting the taphole flows in a conduit (referred to as a “launder”) to a collection point for cooling, disposal, and/or further processing into a saleable product. This process is referred to as “tapping” and may be performed on a continuous or batch basis.

In some processes, molten fluid exits the launder into a granulation system. A common granulation technique involves rapidly quenching the molten fluid in a water bath. Some examples of MSW gasifiers employ water quench systems to granulate slag, which can form an aggregate product. For example, U.S. Pat. No. 5,550,312 describes a waste gasification method that includes a water quenching chamber to granulate molten slag. Other granulation processes are possible, including air-based systems. For example, U.S. Pat. No. 4,147,332 describes a method for granulating molten slag for a metallurgical furnace using an air jet.

Depending on the process design, internal pressure within the process vessel may be below atmospheric pressure (negative gauge pressure), above atmospheric pressure (positive gauge pressure), or approximately equal to atmospheric pressure (neutral pressure). Additionally, process vessels that normally operate at negative or neutral pressures may be designed to handle positive pressure excursions resulting from anomalous operating conditions (e.g. introduction of water in the feed of a MSW gasifier). Given the pressure differential between the internal process vessel environment and the external plant environment, there may be a need to achieve a pressure seal across the taphole. In the case of MSW gasifiers (which generate a gas mixture termed “syngas”, comprising primarily H₂ and CO gas), a pressure seal is essential for several reasons, including: prevention of air infiltration into the gasifier vessel, which could result in unwanted conversion of carbon or CO gas into CO₂ (by the introduction of oxygen from the ambient air), as well as dilution of the syngas product (by the introduction of nitrogen from the ambient air); and prevention of syngas egress into the external plant environment, which could pose a safety hazard to plant personnel. Numerous other processes generate similar gas mixtures as MSW gasifiers, and taphole pressure seals are equally crucial in these applications.

A common approach to establishing a pressure seal across a taphole involves immersing the outlet of a gas-tight launder in a water bath. The outlet of the launder is positioned at a certain depth below the water surface, such that the hydrostatic pressure at the launder outlet is higher (with a suitable factor of safety) than the maximum positive design pressure within the vessel. This ensures that no process gas can escape through the launder outlet. This mechanism can also be employed to ensure that no outside air infiltrates the process vessel, in cases where the internal vessel pressure is below atmospheric pressure. Alternatively, similar arrangements may be employed in the stacks connected to process vessels. In either case, a water seal may be employed to prevent unwanted gas flow in the event of positive or negative pressure excursions within the process vessel. Water seals are described extensively in the art; for example, U.S. Pat. No. 4,425,254 describes a slag removal method for a coal gasification process, in which a water bath is employed to maintain the internal pressure of the gasification reactor during slag removal.

In tapping processes, the taphole may be plugged, thereby preventing outflow of molten fluid from the vessel. Taphole plugging may be intentional (e.g. injecting a clay into the taphole for batch tapping operations) or may be unintentional (e.g. molten fluid from the vessel gradually solidifies within the taphole, causing a blockage). In either case, the taphole must eventually be unplugged to allow for further tapping. Unplugging can be achieved by various means. One approach utilizes a plasma torch to melt through the plugged taphole from the exterior of the vessel. Generally, this approach to unplugging is known as “lancing”, and it is widely described in existing art. For example, U.S. Pat. No. 5,254,829 discloses a method to open a furnace taphole from the exterior of the vessel using a plasma torch.

In some cases, external access to the taphole for the purposes of plugging/unplugging may be considerably restricted by obstacles such as launders and slag granulation equipment. Additionally, some tapping operations may require manual operators in close proximity to the molten fluid, which presents a potential safety hazard. Finally, an automated tapping system, which could enable plugging and unplugging of a taphole without external access to the taphole and without requiring manual operation in the vicinity of the taphole, could be beneficial in these situations. A common approach to enable such operation involves an inductive taphole heating apparatus, which consists of annular coils embedded within the taphole wall. An electrical current is passed through the coils and melts the plug of solid material within the taphole channel by electromagnetic induction. By varying the current flow, the taphole may be plugged and unplugged in a controlled manner. Examples of such systems include U.S. Pat. No. 1,227,069, U.S. Pat. No. 3,014,255, and U.S. Pat. No. 5,968,447. In certain cases, however, material may solidify within the vessel and block the flow into the taphole channel. Inductive taphole heating may not be suitable in these cases, as the heating effect of the coils is limited to the taphole channel and may not melt the solid blockage upstream of the channel.

It would be desirable to have a system for tapping a gasifier vessel without requiring external access to the taphole, which is generally required for conventional lancing techniques but may be limited by equipment (e.g. launders, pressure seals, and slag granulation systems) or by non-straight taphole geometries. It would also be desirable to have a system for removing solid build-up within a gasifier vessel, which may impede tapping by blocking the taphole channel, but cannot be melted by existing inductive heating equipment. It would also be desirable to have a system for tapping a gasifier vessel that maintains a pressure seal between the internal gasifier environment and the external environment, and provides the option of granulating the tapped material (e.g. to generate a saleable product).

### SUMMARY

In one aspect, a tapping system for removing molten fluid from a vessel, the tapping system includes: a taphole assembly configured to receive molten fluid from a vessel; an induction coil encircling at least a portion of a taphole channel in the taphole assembly; a launder assembly configured to receive fluid exiting the taphole channel and to form a pressure seal; and a plasma torch extending into the vessel and configured to direct a plasma plume toward an inlet of the taphole channel.

### BRIEF DESCRIPTION OF THE DRAWINGS

FIG. 1 is cross-sectional view of a portion of a gasification reactor and an automated slag tapping system in accordance with an embodiment of the invention.

FIG. 2 is cross-sectional view of a portion of a gasification reactor and an automated slag tapping system in accordance with another embodiment of the invention.

### DETAILED DESCRIPTION

In one aspect, the present invention relates to an automated tapping system for removing molten slag from gasification reactors or other furnaces. In one embodiment, the tapping system includes: an inductive taphole heating system; a slag granulation system; a launder system with a fluid seal; and plasma torch tuyeres that extend into a reactor vessel (with an optional retraction/extension mechanism).

Plasma gasification reactors (sometimes referred to as PGRs) are a type of pyrolytic reactor known and used for treatment of any of a wide range of materials including, for example, scrap metal, hazardous waste, other municipal or industrial waste and landfill material, and vegetative waste or biomass to derive useful material, e.g., metals, or a synthesis gas (syngas), or to vitrify undesirable waste for easier disposition.

Various gasification reactor designs are known in the art. One example of a plasma gasification reactor is described in US Patent Application Publication US2012/0199795, which is incorporated by reference herein. An example plasma gasification reactor includes a refractory-lined reactor vessel, one or more feed ports for inserting feed material into the vessel, one or more plasma torches configured to heat material in the reactor vessel, one or more slag and molten metal tap holes, and one or more tuyeres for inserting additional process material into the vessel.

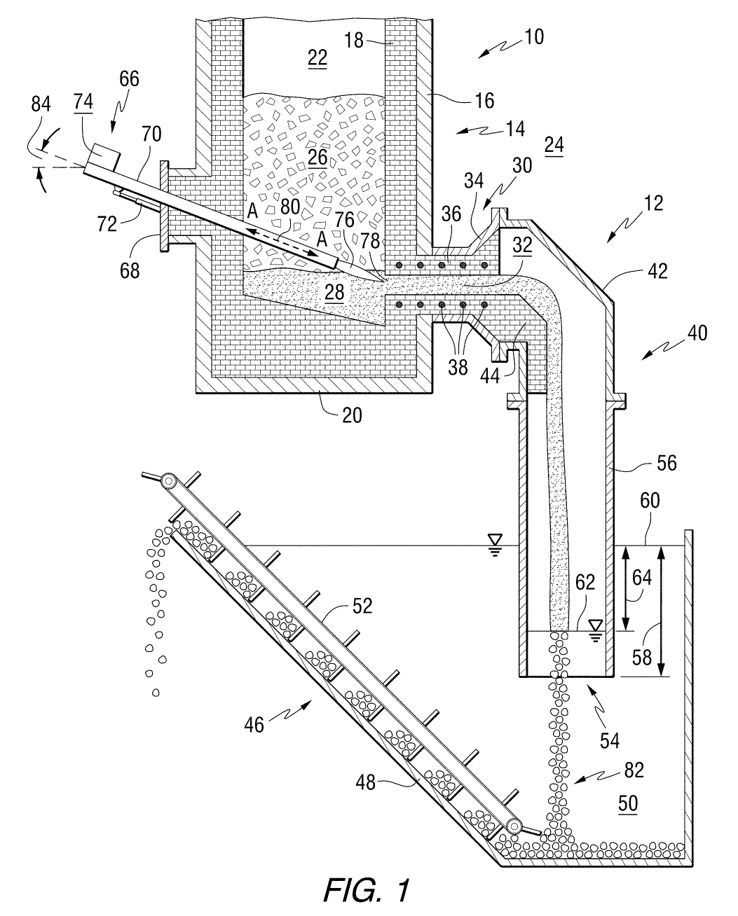

FIG. 1 is cross-sectional view of a portion of a gasification reactor vessel 10 and an automated slag tapping system 12 in accordance with an embodiment of the invention. The bottom portion 14 of a gasifier vessel 10 includes a water-cooled shell 16, a refractory lining 18, a base (referred to as a “hearth”) 20, an internal environment 22 which may include a syngas, and an external environment 24 which represents the plant space and is at atmospheric pressure. The internal environment 22 may be at negative or positive gauge pressure. Also shown are simplified profiles of the feed material 26 (which may include, for example, MSW and coke) and molten slag 28. Several major components of the gasifier vessel 10 that do not pertain to the invention described herein are omitted for clarity. These components include feed ports, oxygen/steam tuyeres, syngas off-takes, and primary plasma torches, such as those shown in US Patent Application Publication US2012/0199795A.

FIG. 1 includes a taphole assembly 30 including a taphole channel 32 depicted in an “open” configuration (i.e. there is no plug and the molten slag flows freely through the taphole channel). The taphole assembly 30 includes a taphole shell 34, a taphole refractory lining 36, a taphole channel 32, and induction heating coils 38, which are positioned annularly around the taphole channel 32. In this example, some of the induction heating coils are located in the refractory lining of the gasifier vessel.

The taphole assembly 30 is connected to a gas-tight launder assembly 40, which comprises a launder shell 42 and a launder refractory lining 44. The launder discharges into a slag granulation chamber 46, which includes a shell 48, a water reservoir 50, and a drag chain conveyor 52. The outlet 54 of a portion 56 of the launder 40 is immersed in the water reservoir 50 to a certain depth 58. A first surface 60 of the water reservoir 50 is exposed to the external environment 24 and is therefore at atmospheric pressure. A second surface 62 of the water reservoir 50 is located within the launder 40 and is therefore at the pressure of the internal environment 22. In this example, the pressure of the internal environment 22 is greater than atmospheric pressure; this results in a height differential 64 where the second surface 62 is lower than the first surface 60. The second surface 62 is effectively “pushed” down by the gas pressure within the internal environment 22 until the internal gas pressure is equalized by the hydrostatic pressure caused by the weight of the water between the first surface 60 and the second surface 62. The launder assembly of FIG. 1 forms a pressure seal between the internal environment and the external environment. As long as the depth 58 of the launder outlet 56 is greater than the height differential 64, the pressurized syngas within the internal environment 22 cannot escape the gas-tight launder 40 into the external environment 24. While not shown in FIG. 1, it can be appreciated that this configuration may also prevent infiltration of air from the external environment 24 into the internal environment 22.

Also shown in FIG. 1 is a retractable plasma torch apparatus 66, which comprises a plasma torch nozzle 68, a water-cooled plasma torch 70, an actuator 72, and a mechanical rapping device 74. The plasma torch 70 extends into the gasifier vessel 10 and is configured to direct a plasma plume 76 toward an entrance 78 to the taphole channel. The actuator 72 is operable to move the plasma torch 70 toward or away from the entrance to the taphole channel 32 in a direction generally parallel to that illustrated by arrow 80.

With continued reference to FIG. 1, the operation of the depicted automated tapping system 12 can now be described. Molten slag 28 flows through into the taphole channel 32 by gravity, due to the incline of the refractory lining 18 above the hearth 20. Molten slag 28 flows from the taphole channel 32 into the launder 40 and exits through the launder outlet 54 into the water reservoir 50. The molten slag 28 typically includes metallic components that can be heated by the induction coils.

The molten slag 28 is rapidly cooled in the water reservoir 50 and solidifies as granulated slag 82, which is collected from the base of the slag granulation chamber 48 by the drag chain conveyor 52. The drag chain conveyor 52 discharges the granulated slag 82 from the slag granulation chamber 48 for collection (collection equipment not shown). In some cases (e.g. with certain MSW gasifiers), the above-described process operates continuously (i.e. there is a constant outflow of molten slag 28 from the taphole channel 32), although the described equipment could also be employed with processes involving intermittent tapping.

During tapping operations, cooling and solidification of molten slag 28 within the taphole channel 32 is undesirable as it can eventually lead to blockage of the molten slag 28 flow. To prevent this, an electrical current is passed through the induction heating coils 38 surrounding the taphole channel 32. This inductively heats the molten slag 28 within the taphole channel 32 such that it remains in a liquid state.

In some instances, such as planned maintenance periods, it may be desired to plug the taphole channel 32 to prevent further outflow of molten slag 28. This may be accomplished by stopping the flow of current through the induction heating coils 38 such that the molten slag 28 gradually solidifies into a solid plug within the taphole channel 32. The induction coils can receive current from an external power supply and/or control system, not shown.

In the automated slag tapping system of FIG. 1, it can be understood that the area of influence of the induction heating coils 38 is essentially limited to the taphole channel 32. In the event of slag solidification elsewhere in the gasifier vessel 10 (for example, near the inlet 78 of the taphole channel 32), the inductive heating process may be insufficient to prevent blockage of the taphole 40. In some examples, the inductive heating process may be supplemented with a retractable plasma torch apparatus 66. This apparatus extends/retracts a plasma torch 70 through the gasifier vessel 10 and melts solid build-ups near the inlet 78 of the taphole channel 32 using a high temperature plasma jet 76. In this example, the plasma torch 70 enters the gasifier vessel 10 through a nozzle 68 which is diametrically opposite the taphole assembly 30. The portion of the plasma torch 70 that extends into the gasifier vessel 10 can be water-cooled. Any gaps between the nozzle 68 and the plasma torch 70 wall could be sealed using packed seals, gas purges, or other methods. An actuator 72 (which could be a hydraulic, pneumatic, or other type), located outside the gasifier vessel 10, is employed to position the plasma torch 70 along axis A-A 80. Because the plasma torch 70 is water-cooled, there is a possibility of molten slag 28 solidifying onto the outer surface of the plasma torch 70, thereby preventing smooth retraction of the plasma torch 70. In this example, a mechanical rapping device 74 is located outside the gasifier vessel 10 and is employed to remove solid build-up on the plasma torch 70 by repeatedly striking a portion of the plasma torch 70. Other mechanisms to remove build-up, such as vibratory devices or scrapers, are possible but are not described here.

It can be appreciated that a retractable plasma torch 70 may offer performance benefits over a fixed torch in certain applications. First, it allows the plasma jet 76 to be positioned at various points within the gasifier vessel 10. This enables melting of solid build-up not only in the vicinity of the inlet 78 of the taphole channel 32, but also in other areas of the gasifier vessel 10. For example, in some processes a large solid mass may develop near the center of the gasifier vessel 10, which restricts upflow of syngas generated by the gasification reaction to a thin annulus near the periphery of the internal environment 22. Such a restriction increases the velocity of the syngas at the refractory 18 wall, thereby accelerating refractory wear. The retractable plasma torch 70 could be re-positioned to melt such solid masses and thus improve refractory life. Additionally, retraction may enable easier online maintenance/inspection of the plasma torch 70.

In the example of FIG. 1, the plasma torch 70 is oriented at an angle 84, and passes through the gasifier vessel 10 wall at a location such that the portion of the plasma torch 70 that extends into the vessel is positioned within a bed of the feed material 26 and above the pool of molten slag at the bottom of the vessel. Selection of the preferred angle 84 will depend on the geometry of the gasifier vessel 10 and operating parameters of the particular gasification process.

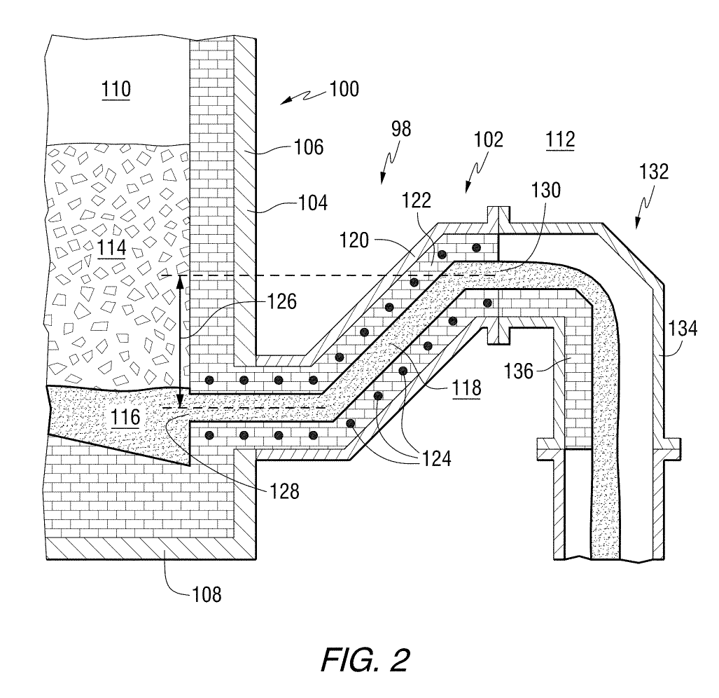

FIG. 2 is cross-sectional view of a portion of a gasification reactor vessel 100 and an automated slag tapping system 98 in accordance with another embodiment of the invention. The bottom portion of a gasifier vessel 100 includes a water-cooled shell 104, a refractory lining 106, a hearth 108, an internal environment 110 which includes syngas, and an external environment 112 which represents the plant space and is at atmospheric pressure. As with the system of FIG. 1, the internal environment 110 may be at negative or positive gauge pressure. Also shown are simplified profiles of the feed material 114 and molten slag 116. Several major components of the gasifier vessel 100 and the automated slag tapping system 98 are omitted for clarity.

Referring to FIG. 2, a taphole channel 118 in the tapping assembly is depicted in an “open” configuration. The taphole assembly 102 includes a taphole shell 120, a taphole refractory lining 122, a taphole channel 118, and induction heating coils 124, which are positioned annularly around the taphole channel 118, within the taphole refractory lining 122 and the refractory lining 106 of the gasifier vessel 100. In this example, the taphole assembly 102 is upwardly inclined such that a height differential 126 is achieved between the inlet 128 of the taphole channel 118 and the outlet 130 of the taphole channel 118. The taphole assembly 102 is connected to a launder 132, which comprises a launder shell 134 and a launder refractory lining 136. The launder 132 may discharge into a slag granulation chamber (not shown) or other vessel (e.g. a receptacle for transport, also not shown). Note that in this example, the launder 132 is not necessarily gas-tight.

Again referring to FIG. 2, it can be understood that the inlet 128 of the taphole channel 118 may be at approximately the same pressure as the internal environment 110, while the outlet 130 of the taphole channel 118 may be at approximately the same pressure as the external environment 112 (i.e. atmospheric pressure). In the case that the pressure of the internal environment 110 is greater than the pressure of the external environment 112, it can be appreciated that a sufficiently large height differential 126 of the molten slag 116 within the taphole channel 118 will produce a hydrostatic pressure at the inlet 128 of the taphole channel 118 that could counteract the pressure within the internal environment 110 and prevent egress of syngas from the internal environment 110 into the external environment 112. It can also be appreciated that this mechanism may also prevent infiltration of air from the external environment 112 into the internal environment 110, although this is not specifically depicted in FIG. 2.

With continued reference to FIG. 2, the operation of the depicted automated tapping system 98 is similar to the first example described in FIG. 1. Molten slag 116 flows through the taphole channel 118 by gravity and into the launder 132. Molten slag 118 is discharged from the launder 132 into a slag granulation system (not shown) or other vessel. In this embodiment, because the pressure seal is achieved by the height differential 126 of the molten slag 116, a water seal (such as that depicted in FIG. 1) is not necessary. This allows for alternative slag granulation processes, such as air granulation (although water granulation is still possible).

Referring to FIG. 2, the induction heating mechanism operates in the same fashion as the system illustrated in FIG. 1. An electrical current is passed through the induction heating coils 124 surrounding the taphole channel 118. This inductively heats the molten slag 116 within the taphole channel 118 such that it remains in a liquid state. As with the embodiment in FIG. 1, plugging of the taphole channel 118 can be accomplished by stopping the flow of current through the induction heating coils 124. In this embodiment, the induction heating mechanism can keep the molten slag 116 in a fluid state within the non-straight geometry of the taphole channel 118, which may preclude conventional unplugging techniques (e.g. lancing from the outside of the gasifier vessel 100).

Finally, while not shown in FIG. 2, it can be appreciated that a retractable plasma torch apparatus (identical to that depicted in FIG. 1) can be employed in the example of FIG. 2 (e.g. to melt solid build-up outside the area of influence of the inductive heating coils 124).

It should be recognized that many variations of the embodiments described herein are also encompassed by the invention. Such variations include: multiple tapholes/launders/slag granulation chambers; multiple retractable plasma torches; fixed (i.e. non-retractable) plasma torches; different taphole/launder orientations (e.g. centrally positioned at the base of the gasifier vessel); alternative granulated slag discharge mechanisms; and/or various means for dislodging frozen slag from the surface of the plasma torch.

The automated tapping system embodiments described herein are designed to enable tapping operations (i.e. plugging and unplugging) without human intervention or external access to the taphole, for example where access to the taphole is limited external by equipment (e.g. launders, pressure seals, slag granulation systems, etc.), and/or a non-straight taphole geometry (which would preclude use of conventional taphole lancing techniques).

The described embodiments maintain a pressure seal (using either molten slag or water as the sealing fluid) to enable operation at either positive or negative internal gasifier pressures. Molten slag can be conveyed in a launder from the taphole channel to a downstream receptacle or process (e.g. a slag granulation system). The molten slag can be granulated using either water or air to generate a saleable product.

While particular aspects of the invention have been described above for purposes of illustration, it will be evident to those skilled in the art that numerous variations of the details of the present invention may be made without departing from the invention as defined in the appended claims.

What is claimed is:

1. A tapping system for removing molten fluid from a vessel, the tapping system comprising:
a taphole assembly configured to receive molten fluid from a vessel;
an induction coil encircling at least a portion of a taphole channel in the taphole assembly;
a launder assembly configured to receive fluid exiting the taphole channel and to form a pressure seal; and
a plasma torch extending into the vessel and configured to direct a plasma plume toward an inlet of the taphole channel.

2. The tapping system of claim 1, wherein the plasma torch is moveable toward or away from the inlet of the taphole channel.

3. The tapping system of claim 1, wherein the taphole assembly comprises:
a taphole shell and a taphole refractory lining around the taphole channel.

4. The tapping system of claim 1, wherein the launder assembly comprises:
a launder shell and a launder refractory lining adjacent to a portion of an internal wall of the launder shell.

5. The tapping system of claim 1, further comprising:
a granulator configured to receive the molten fluid from the launder, the granulator configured to contain a liquid reservoir, wherein the launder outlet is positioned below the surface level of the liquid in the reservoir, such that either syngas egress from an internal environment to an external environment, or air ingress from the external environment into the internal environment, is prevented.

6. The tapping system of claim 1, wherein the plasma torch is water cooled.

7. The tapping system of claim 1, further comprising:
an actuator for positioning the plasma torch.

8. The tapping system of claim 1, further comprising:
a rapper configured to strike the plasma torch.

9. The tapping system of claim 1, further comprising:
a vibrator configured to vibrate the plasma torch.

10. A tapping system for removing molten fluid from a vessel, the tapping system comprising:
a taphole channel configured to receive molten fluid from a vessel, the taphole channel having an inlet and an outlet, wherein the inlet is lower than the outlet;
an induction coil encircling at least a portion of the taphole channel; and
a plasma torch extending into the vessel and configured to direct a plasma plume toward the inlet of the taphole channel.

11. The tapping system of claim 10, wherein:
a height differential of the molten slag within the taphole channel produces a hydrostatic pressure at the taphole channel inlet to counteract a pressure within an internal environment of the vessel and prevent egress of syngas from the internal environment into an external environment.

12. The tapping system of claim 10, wherein the plasma torch is moveable toward or away from the inlet of the taphole channel.

13. The tapping system of claim 10, wherein the taphole assembly comprises:
a taphole shell and a taphole refractory lining around the taphole channel.

14. The tapping system of claim 10, wherein the plasma torch is water cooled.

15. The tapping system of claim 10, further comprising:
an actuator for positioning the plasma torch.

16. The tapping system of claim 10, further comprising:
a rapper configured to strike the plasma torch.

17. The tapping system of claim 10, further comprising:
a vibrator configured to vibrate the plasma torch.

18. The tapping system of claim 10, further comprising:
a launder assembly configured to receive fluid exiting the taphole channel.

19. The tapping system of claim 18, wherein the launder assembly comprises:
a launder shell and a launder refractory lining adjacent to a portion of an internal wall of the launder shell.
